(19) United States
(12) Patent Application Publication
(10) Pub. No.: US 2016/0118805 A1
(43) Pub. Date: Apr. 28, 2016

(54) WIRELESS POWER TRANSFER SYSTEM AND METHOD THEREOF

(71) Applicant: Motorola Solutions, Inc, Schaumburg, IL (US)

(72) Inventors: CHARLES B. SWOPE, Coral Springs, FL (US); LENG H. OOI, Plantation, FL (US)

(21) Appl. No.: 14/522,949

(22) Filed: Oct. 24, 2014

(51) Int. Cl. H02J 5/00

(52) U.S. Cl. CPC H02J 5/005

(57) ABSTRACT

A wireless power transfer system and method is provided. The system includes a source coil that is coupled to a power supplying device and a receiver coil that is coupled to a power receiving device. In operation, when the source coil is energized by the power supplying device and the receiver coil is positioned within a predetermined range of distances from the source coil, the receiver coil is inductively coupled to the source coil at a predefined magnetic resonance frequency to wirelessly transfer power from the power supplying device to the power receiving device. The power receiving device measures a voltage level at the receiver coil and sends information pertaining to the voltage level to the power supplying device. The power supplying device adjusts voltage at the source coil based on comparing the voltage level with a predetermined threshold determined for the power receiving device.

### FIELD OF THE DISCLOSURE

The present disclosure relates generally to a power transfer system and more particularly to a system and method for providing wireless power transfer between devices.

### BACKGROUND OF THE INVENTION

Portable radios such as battery operated hand-held radios are utilized within a variety of public safety environments, such as law enforcement, fire rescue, and emergency medical environments to name a few. Public safety personnel working in the field often carry a number of accessories for their day to day operation. However, it is not always possible for public safety personnel working in unfavorable conditions to find power supplies or carry enough batteries to power the accessories.

Accordingly, there is a need for an efficient mechanism to supply power for one or more devices carried by personnel working in fields.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless power transfer system in accordance with some embodiments.

FIG. 2 is a block diagram of a portable radio system in accordance with some embodiments.

FIG. 3 is a block diagram of an accessory device in accordance with some embodiments.

FIG. 4 is a flowchart of a method of operating a power supplying device to perform wireless power transfer operation in accordance with some embodiments.

FIG. 5 is a message flow diagram illustrating the communication between a power supplying device and one or more power receiving devices in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A wireless power transfer system and method is provided. The system includes a source coil that is coupled to a power supplying device and a receiver coil that is coupled to a power receiving device. In operation, when the source coil is energized by the power supplying device and the receiver coil is positioned within a predetermined range of distances from the source coil, the receiver coil is inductively coupled to the source coil at a predefined magnetic resonance frequency to wirelessly transfer power from the power supplying device to the power receiving device. The power receiving device measures a voltage level corresponding to the power transferred therein and sends information pertaining to the voltage level to the power supplying device. In response, the power supplying device adjusts voltage at the source coil based on comparing the voltage level with a predetermined threshold determined for the power receiving device.

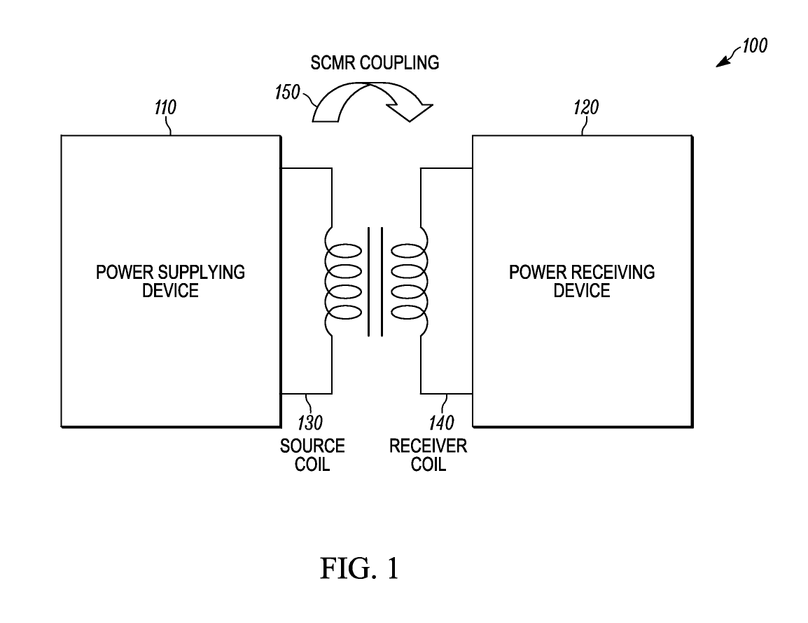

FIG. 1 is a block diagram of a wireless power transfer system 100 operating in accordance with various embodiments. The wireless power transfer system 100 comprises of a power supplying device 110 and a power receiving device 120. The power supplying device 110 may be any electronic device having a power supply (not shown) and wireless communication capability (not shown). The power supply may include various sources such as electrical energy transmission systems, energy storage devices such as batteries and fuel cells, generators, solar power converters, and the like. In one embodiment, the power supplying device 110 is a portable radio device having a limited power supply source such as a battery and radio frequency (RF) wireless communication capability. The power receiving device 120 may be any electronic device having a power receiving function (not shown) and wireless communication capability (not shown). The power receiving function may include energy transmission circuits and/or energy storage devices. In one embodiment, the wireless communication capability of the power supplying device 110 and power receiving device 120 involves the use of one or more low power wireless technologies (Bluetooth®, Wi-Fi, IEEE 802.15 standards, near-field communication (NFC) etc.) for establishing short range wireless communication or personal area network connection. In one embodiment, the power receiving device 120 sends a request for wireless power transfer or charging to the power supplying device 110 after establishing a short range wireless connection with the power supplying device 110. In response to this request, the power supplying device 110 sends an acknowledgment to the power receiving device 120 via the established short range wireless connection if it is able to support the request for wireless power transfer (interchangeably referred to as wireless charging) and initiates a wireless power transfer operation.

The wireless power transfer system 100 further comprises a source coil 130 and a receiver coil 140. The wireless power transfer operation between the power supplying device 110 and power receiving device 120 is achieved by implementing a source coil 130 at the power supplying device 110 and a receiver coil 140 at the power receiving device 120. The source coil 130 and receiver coil 140 may take form of an electrical conductor (e.g. an inductor) such as a wire in the shape of a coil, spiral, or helix that is capable of generating a magnetic field when an electrical current is passed through it. During the wireless power transfer operation, the source coil 130 is capable of wirelessly transferring power to the receiver coil 140 when the source coil 130 is energized by the power supplying device 110 and further when the receiver coil 140 is positioned within a predetermined range of distances (for example, within a tolerance range of 0-200 meters) from the source coil 130. In one embodiment, the source coil 130 is required to resonate at the same frequency (a predetermined magnetic resonant frequency) as that of the receiver coil 140 to inductively couple to the receiver coil 140 and wirelessly transfer power between the power supplying device 110 and power receiving device 120. In order for the power transfer to be efficient between the source coil 130 and receiver coil 140, a strongly coupled magnetic resonance (SCMR) frequency is used in the embodiments of the present disclosure to produce a SCMR coupling 150 between the source coil 130 and the receiver coil 140. As used herein, the term ‘SCMR frequency’ refers to a frequency at which both the source coil 130 and the receiver coil 140 are inductively coupled to achieve a maximum possible efficiency in the transfer of electrical energy between the power supplying device 110 and power receiving device 120. The SCMR frequency used to achieve maximum energy transfer efficiency varies between devices, and can depend on multiple factors such as size, shape, material, number of coil windings of the source coil 130 and receiver coil 140, operating voltage of the power supplying device 110 and power receiving device 120, power supply capacity of the power supplying device 110, energy transmission/storage capacity of the power receiving device 120, distance between the power supplying device 110 and power receiving device 120, environmental factors (interference), and the like. In one embodiment, when the power supplying device 110 is a public safety portable radio device used in land mobile radio (LMR) communication systems and the power receiving device 120 is a public safety accessory device used to support LMR communication, the SCMR frequency is predetermined to be within a tolerance range of 6.78 MHz to achieve a maximum possible efficiency during the wireless power transfer operation between such devices.

In public safety environments, portable radio devices/battery packs (power supplying devices 110) can be adapted to function as a wireless charger for a number of accessory devices (power receiving devices 120) such as remote speaker microphones, integrated glass displays, sensors such as proximity sensors, biometric sensors, gun holster sensors, or environmental sensors, or other collaborative electronic accessory devices supporting public safety broadband communication and mission critical applications. However, this situation requires utilizing a limited power supply source (such as a battery pack) or a battery powered device (such as a portable radio device) as the power supplying device 110 to charge devices/accessories which may further drain the limited power capacity of the power supplying device 110. The embodiments of the present disclosure described herein provide a solution to manage the power drain of the power supplying device 110 and also address an overvoltage condition of the power receiving device 120 during the wireless power transfer operation between such devices. In one embodiment, the power supplying device 110 adjusts voltage at the source coil 130 to provide power transfer capability in response to external voltage information such as an overvoltage condition at the power receiving device 120. In this embodiment, the power supplying device 110 reduces the voltage at the source coil 130 when a voltage level measured at the receiver coil 140 is greater than a predetermined threshold level determined for the power receiving device 120. Otherwise, the power supplying device 110 maintains the voltage at the source coil 130 when the voltage level measured at the receiver coil 140 is not greater than the predetermined threshold level determined for the power receiving device 120. This regulation or maintenance of voltage at the source coil 130 in response to voltage condition at the receiver coil 140 ensures that the power supplying device 110 is not providing more power than required by the power receiving device 120 at any given time.

The power receiving device 120 communicates information pertaining to the voltage level measured at the receiver coil 140 using the short range wireless connection. In one embodiment, the power drain in the power supplying device 110 is managed by de-energizing the source coil 130 whenever it is determined that the voltage at the source coil 130 has already reached a maximum operating voltage, which indicates that the power supplying device 110 is unable to satisfy the power requirements (for example, voltage requirement) of the power receiving device 120 even with the application of maximum operating voltage at the source coil 130. In one embodiment, the source coil 130 is de-energized when the power supplying device 110 receives information indicating that the power requirements of the power receiving device 120 is fully satisfied (e.g. when the power receiving device 120 is fully charged). This ensures that the power capacity of the power supplying device 110 is not unnecessarily drained as the source coil 130 is maintained in an energized state only as long as the power supplying device 110 continues to satisfy the power requirements of the power receiving device 120.

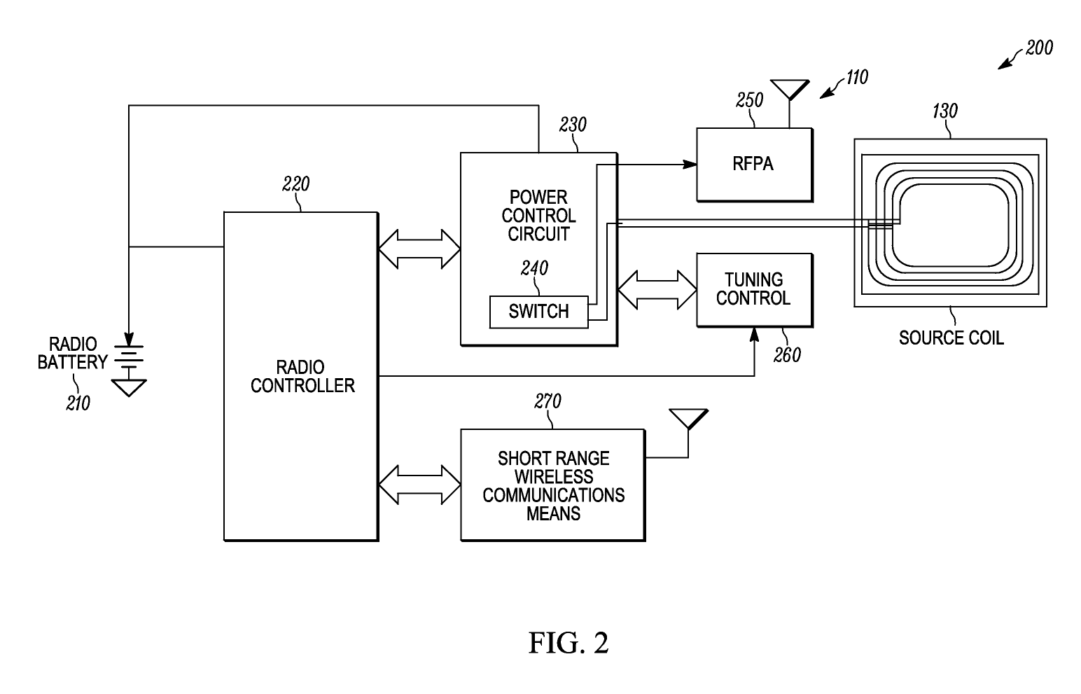

FIG. 2 is a block diagram of a portable radio system 200. The portable radio system 200 may be a two-way communication radio, mobile telephone, wireless telephone, a cellular telephone, a cordless telephone, a two-way pager, a wireless messaging device, a laptop/computer, and the like. The portable radio system 200 comprises a device such as the power supplying device 110 (see FIG. 1) coupled to the source coil 130. In one embodiment, the power supplying device 110 is a battery pack which is removably attached to a portable radio device. The power supplying device 110 of the portable radio system 200 includes a radio battery 210, radio controller 220, power control circuit 230 including a switch 240, radio frequency (RF) power amplifier (PA) 250, tuning control 260, and a short range wireless communication means 270. The radio battery 210 acts as a power source and supplies power to other parts of the portable radio system 200 such as radio controller 220, power control circuit 230, RF power amplifier 250, tuning control 260, and source coil 130. The radio controller 220 acts a controller for various circuitries/components associated with the portable radio system 200. The radio controller 220 includes one or more microprocessors, microcontrollers, DSPs (digital signal processors), state machines, logic circuitry, or any other device or devices that process information based on operational or programming instructions stored in a memory (not shown) of the portable radio system 200. The power control circuit 230 is coupled to the radio battery 210. The power control circuit 230 regulates: (i) an output voltage applied to the RF power amplifier 250 when the portable radio system 200 functions in RF communication mode; and (ii) an output voltage applied to the source coil 130 when the portable radio system 200 is adapted to function as a wireless charger. In one embodiment, the power control circuit 230 includes one or more resistors whose resistance value is altered by the radio controller 220 to adjust the output voltage applied to the RF power amplifier 250 and source coil 130. The power control circuit 230 further includes a switch 240 that adapts the portable radio system 200 to function as a wireless charger. The switch 240 couples the power control circuit 230 to apply output voltage either to the RF power amplifier 250 or source coil 130 based on the instruction received from the radio controller 220. In one embodiment, the switch 240 is a high voltage metal oxide semiconductor field-effect transistor (MOSFET) device that is configured to apply the output voltage from the power control circuit 230 to either the RF power amplifier 250 or source coil 130 at any given point of time.

The RF power amplifier 250 is configured to increase power of a signal coupled to an input of the RF power amplifier 250. In one embodiment, the RF power amplifier 250 is configured to amplify a modulated baseband signal coupled to an input of the RF power amplifier 250 to produce an RF output signal to allow the portable radio system 200 to function in RF communication mode for establishing long range wireless communication with other devices. In accordance with embodiments of the present disclosure, the radio controller 220 controls the switch 240 to connect the power control circuit 230 to the RF power amplifier 250. This allows the RF power amplifier 250 to draw a first supply voltage from the power control circuit 230 and further energize an antenna coupled to the RF power amplifier 250 during RF communication mode. In one embodiment, when the portable radio system 200 is used to support LMR communication systems, the first supply voltage is within a predetermined tolerance range of 25-35 volts. When the radio controller 220 receives a request for wireless charging or power transfer from at least one other device, for example, power receiving device 120 via short range wireless communications means 360, the radio controller 220 controls the switch 240 to switch a connection of the power control circuit 230 to the source coil 130 and further controls the power control circuit 230 to increase the output supply voltage from the first supply voltage (used for RF communication mode, for example 28 volts) to a second supply voltage (used for wireless charging mode, for example 48-50 volts) to energize the source coil 130. In this embodiment, the energization of the source coil 130 with the second supply voltage inductively couples the source coil 130 to the receiver coil 140 at a predefined magnetic resonance frequency (i.e. at SCMR frequency) to allow power transfer from the power supplying device 110 to the power receiving device 120. In one embodiment, when the portable radio system 200 is used to provide wireless power transfer to public safety accessory devices, the second supply voltage is within a predetermined tolerance range of 45-55 volts. In another embodiment, when the portable radio system 200 includes a power supply source that is capable of providing large power capacity, the second supply voltage can be increased to a value between 50-100 volts to provide wireless power transfer to devices having high energy requirements.

The tuning control 260 includes tuning circuits that are controlled by the radio controller 220 to select resistance and capacitance values that are required to resonate the source coil 130 at the predefined magnetic resonance frequency. The short range wireless communication means 270 includes various protocols and components that are required to establish short range wireless connection with other devices such as the power receiving device 120 to exchange messages necessary for performing the wireless power transfer operation. In one embodiment, the short range wireless communication means 270 includes a short range wireless transceiver and antenna that operates at low power to perform short range wireless communication with other devices. In one embodiment, the short range wireless communication means 270 employs one or more low power wireless technologies including, but not limited to Bluetooth®, Wi-Fi, IEEE 802.15 standards, and near-field communication (NFC). In accordance with embodiments of the present disclosure, the short range wireless communication means 270 enables the power supplying device 110 to receive power transfer request from the power receiving device 120, send an acknowledgment for the power transfer request to the power receiving device 120, receive an acknowledgment that the power transfer or charging is occurring at the power receiving device 120, receive information pertaining to a voltage level (such as overvoltage condition) measured at the receiver coil 140 from the power receiving device 120 during the wireless power transfer operation, and receive an indication from the power receiving device 120 when the charging or power transfer at the power receiving device 120 is complete.

In one embodiment, when the radio controller 220 receives a request for power transfer from the power receiving device 120, the radio controller 220 determines whether the power supplying device 110 can meet the power requirements of the power receiving device 120 and sends an acknowledgment via the short range wireless communication means 270 if it can wirelessly transfer power while meeting the power requirements of the power receiving device 120. In one embodiment, the radio controller 220 requests for device configuration parameters such as battery capacity, operating voltage, operating frequency, and other device specific parameters from the power receiving device 120. In one embodiment, the radio controller 220 maintains device configuration parameters for a list of devices which are either stored locally or remotely in a database. The radio controller 220 uses the device configuration parameters to determine whether the power supplying device 110 can satisfactorily meet the power requirements of the power receiving device 120, and also further determine a threshold level (herein after referred to as a predetermined threshold level) for comparison with voltages measured at the receiver coil 140. The radio controller 220, after sending the acknowledgment for the power transfer request via the short range wireless communication means 270 to the power receiving device 120, controls the switch 240 to switch the connection of the power control circuit 230 to the source coil 130 and further control the power control circuit 230 to increase the output supply voltage to the second supply voltage that is required to energize the source coil 130.

When the source coil 130 is energized at a predefined magnetic resonance frequency and the receiver coil 140 is positioned within the predetermined range of distances from the source coil 130, the source coil 130 is inductively coupled to the receiver coil 140 to wirelessly transfer power from the power supplying device 110 to the power receiving device 120. In response, the power supplying device 110 receives via the short range wireless communication means 270, information pertaining to a voltage level measured at the receiver coil 140 corresponding to the wireless transfer of power at the power receiving device 120. If the voltage level measured at the receiver coil 140 is greater than the predetermined threshold level for the power receiving device 120, the radio controller 220 controls the power control circuit 230 to reduce the second supply voltage by a predetermined level (for example, 5-10 volts at a time) to avoid overvoltage condition at the power receiving device 120. On the other hand, if the voltage level is not greater than the predetermined threshold level for the power receiving device 120, the radio controller 220 controls the power control circuit 230 to maintain the second supply voltage at the same level. However, if the voltage level is zero or falls within a range of smaller values relative to the predetermined threshold level or if the radio controller 220 receives information via short range wireless communication means 270 that the power transfer is not occurring at the power receiving device 120, the radio controller 220 controls the power control circuit 230 to increase the second supply voltage by a predetermined level to cause power transfer to the power receiving device 120.

At any point in time during the wireless power transfer operation, if the voltage at the source coil 130 has reached its maximum operating voltage or if the radio controller 220 receives indication via the short range wireless communication means 270 that the power requirements of the power receiving device 120 is fully met (i.e. power transfer or charging is complete), the radio controller 220 controls the power control circuit 230 to de-energize the source coil 130. In one embodiment, the radio controller 220 further controls the switch 240 to switch the connection of the power control circuit 230 back to the RF power amplifier 250. In one embodiment, during the wireless power transfer operation, if the radio controller 220 receives a signal to operate in RF communication mode, then the radio controller 220 controls the switch 240 to switch the connection of the power control circuit 230 back to the RF power amplifier 250 in order to operate in RF communication mode. In this embodiment, the radio controller 220 is programmed to provide higher priority for operating in RF communication mode of operation instead of wireless power transfer operation. In portable radio systems supporting LMR communication standards, the duty cycle of a portable radio device typically involves 5% of transmission time, 5% of reception time, and 90% of standby time. In such systems, the embodiments of the present disclosures can be advantageously implemented to provide wireless charging capability to the portable radio device during their (90%) standby time. In one embodiment, the radio controller 220 is programmed to control power control circuit 230 to apply an output supply voltage of 28 volts at less than 1 ampere of current to the RF power amplifier 250 during 5% of transmission time.

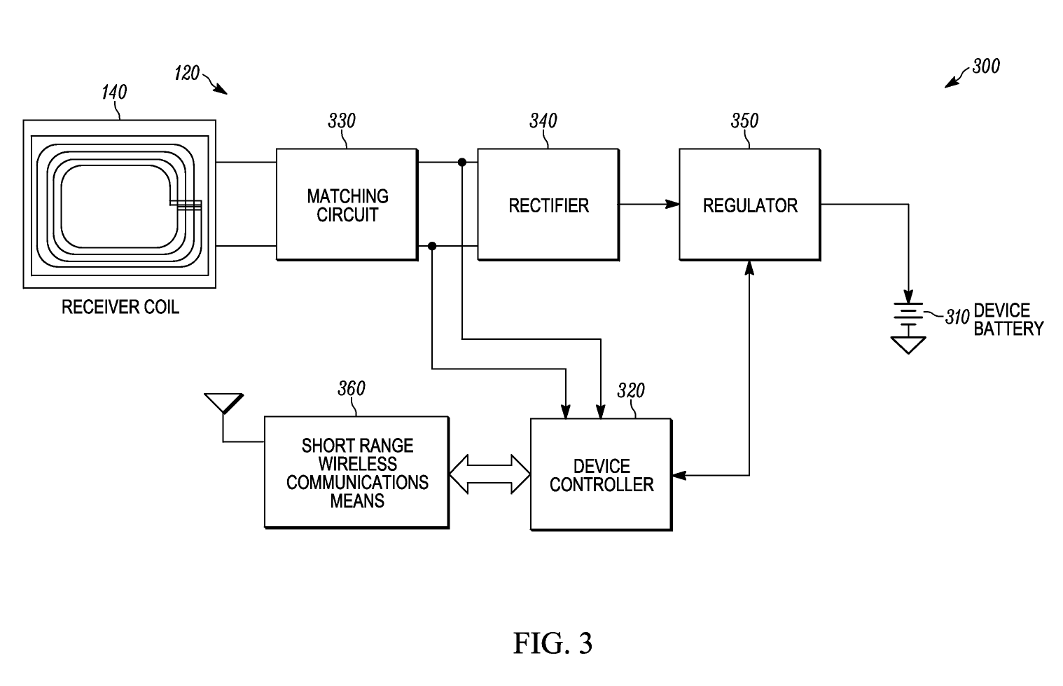

FIG. 3 is a block diagram of an accessory device 300 in accordance with embodiments of the present disclosure. The accessory device 300 may be any electronic device (such as a power receiving device 120 shown in FIGS. 1 and 2) that requires power for its operation and further capable of communicating with a power supplying device 110 (see FIGS. 1 and 2) using a short range wireless connection. In some embodiments, the accessory device 300 may include, but not limited to, remote speaker microphones, integrated glass displays, sensors such as proximity sensors, biometric sensors, gun holster sensors, or environmental sensors, or other collaborative electronic accessory devices supporting public safety broadband communication and mission critical applications. The accessory device 300 comprises a power receiving device 120 coupled to the receiver coil 140. The power receiving device 120 of the accessory device 300 includes a device battery 310, device controller 320, matching circuit 330, rectifier 340, regulator 350, and short range wireless communication means 360. The device battery 310 acts as a power source and supplies power to various components associated with the accessory device 300. In accordance with embodiments of the present disclosure, the device battery 310 is capable of being wirelessly charged by the power supplying device 110 when the receiver coil 140 is inductively coupled to the source coil 130 during the wireless power transfer operation. The device controller 320 acts a controller for various circuitries/components associated with the accessory device 300. The device controller 320 includes one or more microprocessors, microcontrollers, DSPs (digital signal processors), state machines, logic circuitry, or any other device or devices that process information based on operational or programming instructions stored in a memory (not shown) of the accessory device 300.

The receiver coil 140 resonates at the same predefined magnetic resonance frequency as that of the source coil 130 and receives power from the source coil 130 through the SCMR coupling 150 (see FIG. 1). A tuning control (not shown) is provided in the power receiving device 120 to resonate the receiver coil 140 at the predefined magnetic resonance frequency. The matching circuit 330 is configured to match an output impedance of the receiver coil 140 with an input impedance of the rectifier 340. This enables transfer of maximum amount of power to charge the device battery 310 during the SCMR coupling 150. The rectifier 340 rectifies output signals of the matching circuit 330 to produce direct current (DC) voltage and outputs the DC voltage to the regulator 350. The regulator 350 converts the DC voltage into a desired voltage value and supplies the desired voltage value into a load circuit (not shown) or for charging the device battery 310. In one embodiment, the device battery 310 draws approximately 170 mA of battery current at 7.50V nominal battery voltage during wireless power transfer operation.

The short range wireless communication means 360 is similar to short range wireless communication means 270 shown in FIG. 2 and includes various protocols and components that are required to establish a short range wireless connection with other devices such as the power supplying device 110 shown in FIGS. 1 and 2 to exchange messages necessary for performing the wireless power transfer operation. In one embodiment, the short range wireless communication means 360 includes a short range wireless transceiver and antenna that operates at low power to perform short range wireless communication with other devices. In one embodiment, the short range wireless communication means employs one or more low power wireless technologies including, but not limited to Bluetooth®, Wi-Fi, IEEE 802.15 standards, and near-field communication (NFC). In accordance with embodiments of the present disclosure, the short range wireless communication means 270 enable the power receiving device 120 to send power transfer request to the power supplying device 110, send device configuration parameters as required to the power supplying device 110, send an acknowledgment to the power supplying device 110 indicating that the power transfer or charging is occurring at the power receiving device 120, send information pertaining to a voltage level (such as overvoltage condition) measured at the receiver coil 140 to the power supplying device 110 during the wireless power transfer operation, and send an indication to the power supplying device 110 when the charging or power transfer at the power receiving device 120 is complete. In one embodiment, the power receiving device 120 includes a transducer electronic data sheet (TEDS) stored in the memory. The TEDS contain device configuration parameters such as battery capacity, operating voltage, operating frequency, and other device specific parameters for the power receiving device 120. In one embodiment, the power supplying device 110 captures the device configuration parameters directly from the TEDS of the power receiving device 120.

The device controller 320 is configured to detect a user input requesting to wirelessly charge the accessory device 300 via the portable radio system 200 and establish a short range wireless connection with the power supplying device 110 of the portable radio system 200 to initiate the wireless power transfer operation. The device controller 320 sends a wireless power transfer request to the power supplying device 110 via the short range wireless connection means 360. In response to the wireless power transfer request, the device controller 320 receives an acknowledgment via the short range wireless communication means 360 from the power supplying device 110 that confirms whether the power supplying device 110 can satisfy the power requirements of the power receiving device 120. In one embodiment, when the device controller 320 receives an acknowledgment that confirms that the power supplying device 110 can satisfy the power requirements of the power receiving device 120, the device controller 320 energizes the receiver coil 140 to resonate at the predefined magnetic resonance frequency of the source coil 130 in order to wirelessly transfer power from the source coil 130 to the receiver coil 140 through the SCMR coupling 150. In response to detecting SCMR coupling 150 between the source coil 130 and receiver coil 140, the device controller 320 measures a voltage level at the receiver coil 140 to determine if the power transfer or charging is occurring at the power receiving device 120. In one embodiment, if no power transfer or charging is occurring at the power receiving device 120 (i.e. if voltage level is zero or falls within a range of smaller values relative to the predetermined threshold for the power receiving device 120), the device controller 320 sends an acknowledgment to the power supplying device 110 to indicate that no power transfer is occurring at the power receiving device 120. This acknowledgment allows the power supplying device 110 to either increase the voltage at the source coil 130 up to its maximum operating voltage to cause power transfer or discontinue the wireless power transfer operation by de-energizing the source coil 130 if power transfer is not possible. In another embodiment, if the device controller 320 detects that no power transfer is occurring, the device controller 320 provides an alert to the user to correct or adjust the position of the receiver coil 140 of the power receiving device 120 relative to the source coil 130 of the power supplying device 110.

Alternatively, if the device controller 320 detects that the power transfer is occurring at the power receiving device 120 i.e. if it detects the presence of voltage at the receiver coil 140, the device controller 320 sends information pertaining to the voltage level measured at the receiver coil 140 to the power supplying device 110. This information allows the power receiving device 120 to reduce or maintain the voltage supplied to the source coil 130 based on whether an overvoltage condition (i.e a condition when measured voltage is greater than the predetermined threshold level) is occurring or not at the power receiving device 120. The device controller 320 is further configured to detect when the power requirements of the power receiving device 120 is fully satisfied (for example, when the charging of the device battery 310 is complete) and send an indication via the short range wireless communication means 360 to the power supplying device 110. This indication allows the power supplying device 110 to discontinue the wireless power transfer operation by de-energizing the source coil 130.

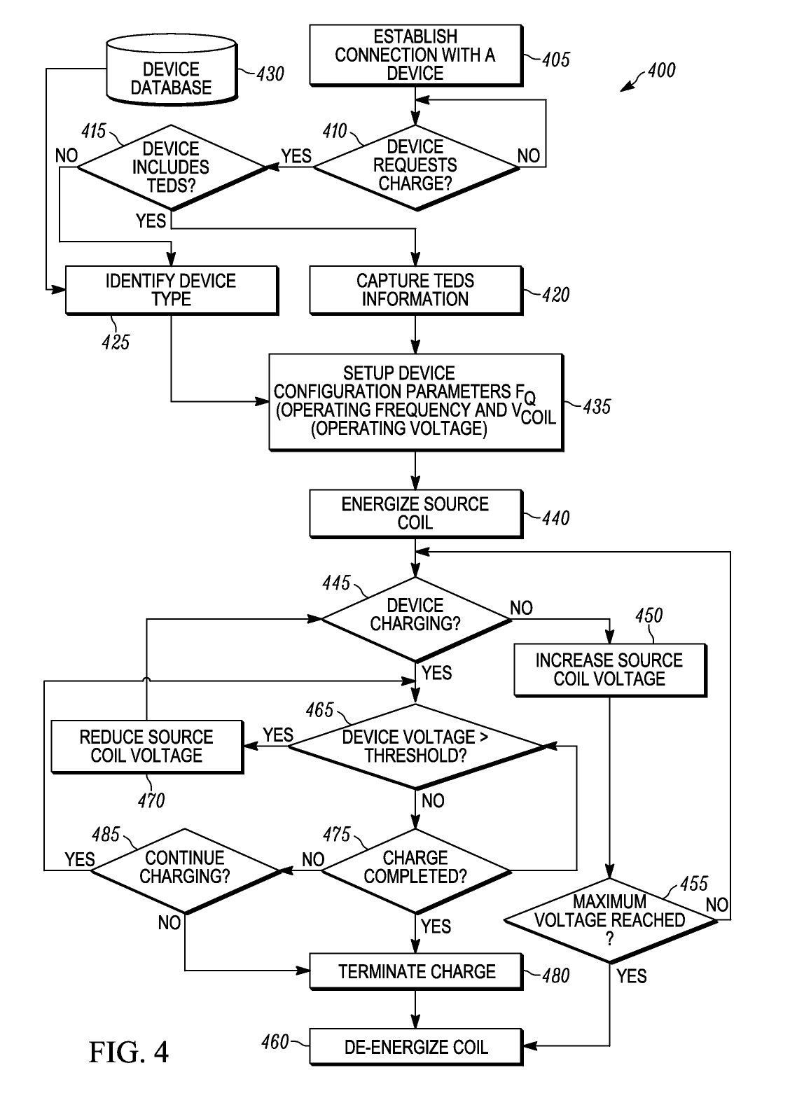

FIG. 4 is a flowchart of a method 400 of operating a device such as a power supplying device 110 shown in FIGS. 1 and 2 to perform the wireless power transfer operation. The method 400 begins at block 405 when the power supplying device 110 establishes a connection with a device such as the accessory device 300. In one embodiment, the power supplying device 110 establishes a short range wireless connection to form a personal area network with one or more accessory devices 300 to exchange messages required for performing the wireless power transfer operation. In one embodiment, the power supplying device 110 establishes a short range wireless connection in response to detecting a user input requesting to charge the accessory device 300. In one embodiment, the power supplying device 110 employs a proximity sensor to detect whether the accessory device 300 is proximal to the power supplying device 110 and then establishes a short range wireless connection with the accessory device 300 that is proximal to the power supplying device 110. Next, at block 410, the power supplying device 110 determines whether the accessory device 300 is requesting to be charged. In one embodiment, the power supplying device 110 receives a wireless charging request via the short range wireless connection from the accessory device 300.

When the power supplying device 110 determines at block 410 that the accessory device 300 is requesting to be charged, the method 400 proceed to block 415 where the power supplying device 110 checks whether the accessory device 300 includes TEDS. The power supplying device 110 captures TEDS information at block 420 if the accessory device 300 includes TEDS information containing the device configuration parameters. Otherwise, at block 425, the power supplying device 110 identifies a device type of the power receiving device 120 and extracts device configuration parameters corresponding to the device type from a device database 430. Next, at block 435, the power supplying device 110 sets up the device configuration parameters including operating frequency (F_{Q}) and operating voltage (V_{coil}) for the accessory device 300 and further determines a voltage threshold level for the accessory device 300. The power supplying device 110 energizes the source coil 130 at block 440. In one embodiment, when the power supplying device 110 of the portable radio system 200 supports long range wireless communication, the power control circuit 230 (see FIG. 2) of the power supplying device 110 may be connected by default to the RF power amplifier 250. In this case, the radio controller 220 of the power supplying device 110 controls the switch 240 (see FIG. 2) to switch a connection of the power control circuit 230 to the source coil 130 and apply the second supply voltage for energizing the source coil 130. This allows the transfer of power between the power supplying device 110 and accessory device 300 through the SCMR coupling 150 (see FIG. 1) between the source coil 130 and receiver coil 140.

The power supplying device 110, at block 445, determines whether charge is occurring at the accessory device 300. In one embodiment, the power supplying device 110 receives an acknowledgment from the accessory device 300 which indicates whether charge is occurring at the accessory device 300. In one embodiment, the power supplying device 110 receives information pertaining to a voltage level measured at the receiver coil 140 from the accessory device 300. When the voltage level at the receiver coil 140 is zero or falls within a range of smaller values (for example 0-10 volts) relative to the predetermined threshold level (for example, 50 volts), the power supplying device 110 determines that charge is not occurring at the accessory device 300. When the power supplying device 110 determines that the accessory device 300 is not being charged through the SCMR coupling 150, the method 400 proceeds to block 450 where the power supplying device 110 increases the voltage that is applied at the source coil 130 by a predetermined level to cause the power transfer from the power supplying device 110 to the accessory device 300. Next, at block 455, the power supplying device 110 determines whether the voltage applied at the source coil 130 has reached maximum operating voltage of the source coil 130. When the voltage applied at the source coil 130 has reached the maximum operating voltage, the power supplying device 110 de-energizes the source coil 130 to avoid draining its power capacity. In one embodiment, it is possible that the distance between the source coil 130 and the receiver coil 140 may be more than the predetermined range of distances that is required for effecting SCMR coupling 150 between the source coil 130 and 140. In such situations, the power transfer to the accessory device 300 may not be possible even with the application of voltage that is closer to maximum operating voltage at the source coil 130 until the source coil 130 and receiver coil 140 are positioned within the predetermined range of distances required for effecting SCMR coupling. Returning to block 455, when the voltage applied at the source coil 130 has not reached the maximum operating voltage, the method 400 continues to check whether charging is occurring at the accessory device 300 (as described in block 445) and increase voltage applied at the source coil 130 (as described in block 450) up to its maximum operating voltage or until it receives a positive acknowledgment indicating that charge is occurring at the accessory device 300.

Returning to block 445, when the power supplying device 110 determines that the charging is occurring at the accessory device 300, the method proceeds to block 465 where the power supplying device 110 determines whether the voltage level (referred to as device voltage in FIG. 4) at the receiver coil 140 is greater than the predetermined threshold level. When the voltage level at the receiver coil 140 is greater than the predetermined threshold level, the power supplying device 110, at block 470, reduces voltage applied at the source coil 130 by a predetermined level until the voltage level at the receiver coil 140 drops and is measured to be not greater than the predetermined threshold. When the voltage level at the receiver coil 140 is not greater than the predetermined threshold, the power supplying device 110 continues to charge the accessory device 300 until it receives an acknowledgment that the charging at the accessory device 300 is completed or it receives an indication from the accessory device 300 that it no longer requires charging. In one embodiment, as shown in block 475, when the power supplying device 110 determines that the charging is completed at the accessory device 300, the method proceeds to block 480 where the power supplying device 110 terminates the charge and de-energizes the source coil 130 at block 460 to discontinue the wireless charging operation.

Returning to block 475, when the power supplying device 110 determines that the charging is not completed at the accessory device 300, the power supplying device 110 determines whether it has received any interrupt either from within the device or from the accessory device 300 that requests for the wireless charging to be discontinued. In one embodiment, the power supplying device 110 may receive the interrupt when there is a user input requesting to discontinue the charging operation or when its battery capacity falls below a predetermined power threshold level or when the device needs to be switched for operation in RF communication mode. For example, as shown in block 485, the power supplying device 110 checks whether it needs to continue to charge the accessory device 300. When the power supplying device 110 receives an interrupt that requests for the wireless charging operation to be discontinued, the method proceeds to block 480 where the power supplying device 110 terminates the charge and de-energizes the source coil 130 at block 460. Otherwise, the method proceeds to block 465 and continues to perform the wireless charging operation until the charging at the accessory device 300 is completed or it receives an interrupt that request for charging operation to be discontinued.

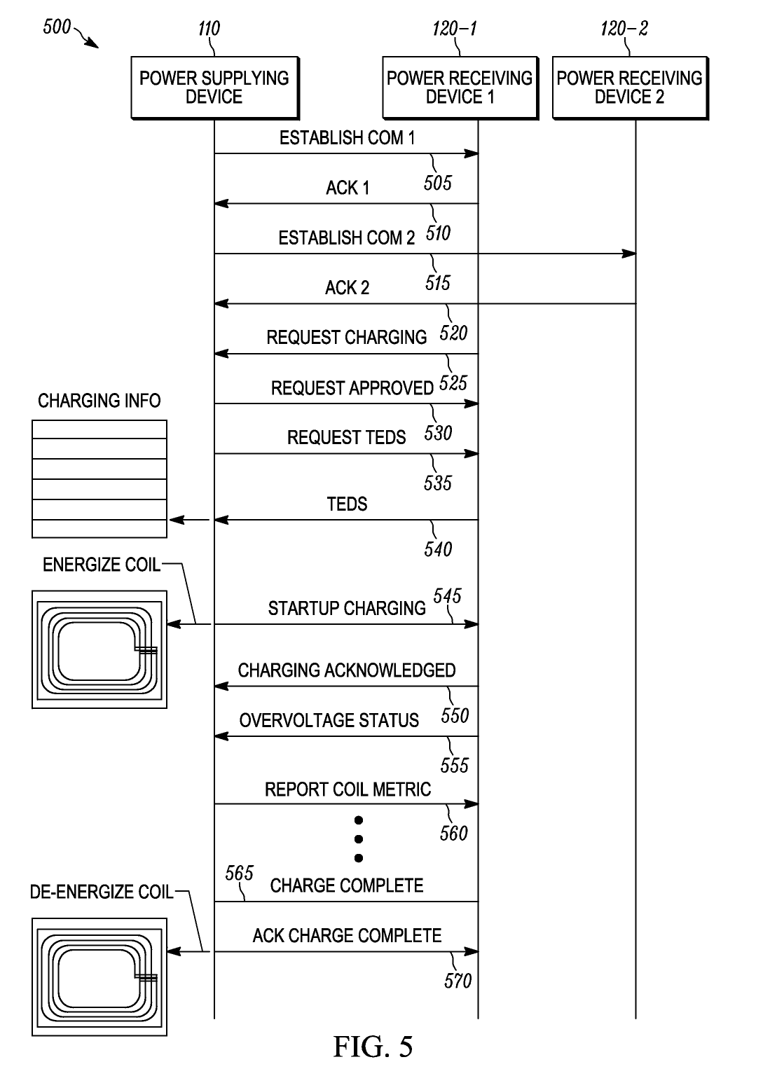

FIG. 5 is a message flow diagram 500 illustrating the communication between devices such as a power supplying device 110 and power receiving devices 120-1, 120-2 during the wireless power transfer operation. The wireless power transfer operation begins when the power supplying device 110 establishes short range wireless connection with one or more power receiving devices 120. As shown in FIG. 5, the power supplying device 110 sends a message 505 for establishing communication with the power receiving device 120-1 and receives an acknowledgment message 510 from the power receiving device 120-1. Similarly, the power supplying device 110 sends a message 515 for establishing communication with the power receiving device 120-2 and receives an acknowledgment message 520 from the power receiving device 120-2. In one embodiment, the messages 505 and 515 contain information advertising the wireless power transfer/charging capability of the power supplying device 110. For example, the messages 505 and 515 contain information such as device type, power capacity, standby time period (i.e. time period and duration for which power transfer/charging is possible), and operating voltage and frequency of the source coil 130.

As show in FIG. 5, the power receiving device 120-1 requests charging from the power supplying device 110 by sending a message 525. In one embodiment, the power receiving device 120-1 analyzes the message 505 to ascertain the wireless charging capability of the power supplying device 110 before sending the message 525 that requests charging from the power supplying device 110. In response to receiving the message 525, the power supplying device 110 approves the charging request by sending a message 530 to the power receiving device 120-1. In one embodiment, the power supplying device 110 determines whether it is able to meet the power requirements of the power receiving device 120-1 prior to approving the charging request via the message 530. Next, the power supplying device 110 requests TEDS from the power receiving device 120-1 by sending a message 535. In response, the power receiving device 120-1 sends TEDS to the power supplying device 110 via a message 540. In one embodiment, the TEDS contains device configuration parameters of the power receiving device 120-1 such as battery capacity, operating voltage and operating frequency of the receiver coil 140, and other device specific parameters from the power receiving device 120-1. In response to receiving the TEDS information from the power receiving device 120-1, the power supplying device 110 energizes the source coil 130 to initiate power transfer between the power supplying device 110 and the power receiving device 120 through the SCMR coupling 150 between the source coil 130 and the receiver coil 140. In one embodiment, as shown in FIG. 5, a message 545 is sent to the power receiving device 120-1 to indicate that charging has been startup by the power supplying device 110. In response, the power receiving device 120-1 sends a message 550 acknowledging that the charging is occurring at the power receiving device 120-1. In the embodiment shown in FIG. 5, the power receiving device 120-1 reports an overvoltage status of the receiver coil 140 by sending a message 555. This information allows the power supplying device 110 to reduce voltage applied at the source coil 130 and thereby limit the voltage at the receiver coil 140 to eliminate the overvoltage status. The power receiving device 120-1 further periodically sends messages 560 to report coil metrics such as voltage level measured at the receiver coil 140 to the power supplying device 110. This information allows the power supplying device 110 to manage draining of its power capacity by adjusting the voltage applied at the source coil 130 in response to voltage level at the receiver coil 140. The power receiving device 120-1 sends a message 565 to the power supplying device 110 to indicate that the charge is completed. In response, the power supplying device 110 de-energizes the source coil 130 to terminate the wireless charging operation and sends a message 570 to the power receiving device 120-1 to acknowledge that the charging is completed.

Embodiments of the present disclosure described above with reference to FIGS. 1-5 can be advantageously employed to wirelessly transfer power between devices. For example, a remote battery charging device, such as two-way radio can be used to charge next generation public safety wearable/accessory devices. Further, the embodiments of the present disclosure can be used to implement a wireless power transfer system that does not depend on unlimited power source that traditional charges rely. Therefore, a battery powered source can be used to charge an accessory device without completely draining the power capacity of the battery powered source. Embodiments of the present disclosure also support use of high frequency (>1 MHz), high power source coil designs for wireless power transfer operation. Implementation of the embodiments of the present disclosures also minimizes the persistent tax on the battery capacity of the power supplying device based on voltage level feedback information (such as overvoltage condition of the receiver coil) received from the power receiving device.

Embodiments of the present disclosure also adapt a portable radio (for example, a portable radio using a 28V power amplifier design) to function as a wireless charger with minimal changes in the existing circuitry of the portable radio. This ensures that the same power supply electronics used in existing two-way portable and mobile radios can be used to power an accessory device. Embodiments of the present disclosure implement a switch in the portable radio that allows the portable radio to switch between RF communication mode and wireless charging mode. The charging mode is enabled when the portable radio is in standby mode and not involved in RF communication.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A wireless power transfer system, comprising:
a source coil coupled to a power supplying device; and
a receiver coil coupled to a power receiving device,
wherein when the source coil is energized by the power supplying device and the receiver coil is positioned within a predetermined range of distances from the source coil, the receiver coil is inductively coupled to the source coil at a predefined magnetic resonance frequency to wirelessly transfer power from the power supplying device to the power receiving device, the power receiving device measures a voltage level at the receiver coil and sends information pertaining to the voltage level to the power supplying device, and the power supplying device adjusts voltage at the source coil based on comparing the voltage level with a predetermined threshold level determined for the power receiving device.

2. The wireless power transfer system of claim 1, wherein the power supplying device:
reduces voltage at the source coil when the voltage level is greater than the predetermined threshold level determined for the power receiving device; and
maintains voltage at the source coil when the voltage level is not greater than the predetermined threshold level determined for the power receiving device.

3. The wireless power transfer system of claim 2, wherein the power supplying device increases voltage at the source coil:
when the voltage level is zero;
when the voltage level falls within a range of smaller values relative to the predetermined threshold level; and
when the power supplying device receives information that the power is not being transferred to the power receiving device.

4. The wireless power transfer system of claim 3, wherein the source coil is de-energized by the power supplying device when the power supplying device determines that the voltage at the source coil has reached a maximum operating voltage or when the power supplying device receives information that the power requirements of the power receiving device is fully satisfied.

5. The wireless power transfer system of claim 1, wherein the power receiving device establishes a short range wireless communication with the power supplying device to request power transfer from the power supplying device and sends device configuration parameters including operating frequency and operating voltage of the receiver coil to the power supplying device.

6. The wireless power transfer system of claim 5, wherein when the power receiving device includes a transducer electronic data sheet (TEDS), the power supplying device captures the device configuration parameters including operating frequency and operating voltage of the receiver coil from the TEDS.

7. The wireless power transfer system of claim 5, wherein the power supplying device determines the predetermined threshold level based on the device configuration parameters of the power receiving device.

8. The wireless power transfer system of claim 1, wherein the power supplying device is a public safety portable radio device having a limited power supply source.

9. The wireless power transfer system of claim 8, wherein the power receiving device is a public safety accessory device including a battery that is wirelessly charged using the power transferred from the public safety portable radio device.

10. The wireless power transfer system of claim 1, wherein the predefined magnetic resonance frequency is a strongly coupled magnetic resonance (SCMR) frequency at which power transfer between the source coil and the receiver coil is efficient.

11. A portable radio system, comprising:
a limited power supply source;
a radio frequency (RF) power amplifier coupled to the limited power supply source for enabling long range wireless communication;
a source coil coupled to the limited power supply source;
a short range wireless communication means; and
a controller coupled to the short range wireless communication means and the source coil, the source coil being energized by the limited power supply source to provide wireless power transfer capability in response to external voltage information being received at the short range wireless communication means.

12. The portable radio system of claim 11, wherein when the source coil is positioned within a predetermined range of distances from a receiver coil of a power receiving device, the source coil inductively couples the receiver coil at a predetermined magnetic resonance frequency to wirelessly transfer power to the power receiving device.

13. The portable radio system of claim 12, wherein the predefined magnetic resonance frequency is a strongly coupled magnetic resonance (SCMR) frequency at which power transfer between the source coil and receiver coil is efficient.

14. The portable radio system of claim 12, wherein the controller determines a predetermined threshold level for the power receiving device based on device configuration parameters received from the power receiving device, the device configuration parameters including operating frequency and operating voltage of the receiver coil.

15. The portable radio system of claim 14, wherein the external voltage information corresponds to a voltage level measured at the receiver coil during the power transfer between the source coil and receiver coil, and further wherein the controller adjusts voltage at the source coil based on a comparison between the voltage level measured at the receiver coil and the predetermined threshold level.

16. The portable radio system of claim 15, wherein the controller:
reduces the voltage at the source coil when the voltage level is greater than the predetermined threshold level determined for the power receiving device;
maintains the voltage at the source coil when the voltage level is not greater than the predetermined threshold level determined for the power receiving device; and
increases voltage at the source coil when it receives information via the short range wireless communication means that the power is not being transferred to the power receiving device.

17. The portable radio system of claim 16, wherein the source coil is de-energized by the limited power supply source when the controller determines that the voltage at the source coil has reached a maximum operating voltage or when the controller receives information that the power requirements of the power receiving device is fully satisfied.

18. A method for wirelessly transferring power from a power supplying device to a power receiving device, the method comprising:
energizing a source coil of the power supplying device to inductively couple a receiver coil of the power receiving device at a predefined magnetic resonance frequency;
measuring a voltage level at the receiver coil when the power is transferred from the power supplying device to the power receiving device through the inductively coupling between the source coil and the receiver coil;
transmitting via a wireless communication means, information pertaining to the measured voltage level to the power supplying device;
comparing the measured voltage level with a predetermined threshold level determined for the power receiving device; and
controlling the power supplying device to adjust voltage at the source coil based on the comparison.

19. The method of claim 18, wherein controlling the power supplying device to adjust voltage further comprises:
reducing the voltage at the source coil when the voltage level is greater than the predetermined threshold level determined for the power receiving device;
maintaining the voltage at the source coil when the voltage level is not greater than the predetermined threshold level determined for the power receiving device; and
increasing voltage at the source coil when it receives information via the wireless communication means that the power is not being transferred to the power receiving device.

20. The method of claim 19, further comprising de-energizing the source coil when the power requirements of the power receiving device is fully satisfied or when the voltage at the source coil has reached a maximum operating voltage.
